(19) United States
(12) Patent Application Publication
(10) Pub. No.: US 2021/0133662 A1
(43) Pub. Date: May 6, 2021

(54) SYSTEM AND METHOD FOR PROVIDING JOB STATUS INFORMATION OF ASSETS

(71) Applicant: Aeris Communications, Inc., San Jose, CA (US)

(72) Inventors: Subramanian Balakrishnan, Cupertino, CA (US); HyungHo Kim, Cupertino, CA (US)

(21) Appl. No.: 17/087,927

(22) Filed: Nov. 3, 2020

Related U.S. Application Data
(60) Provisional application No. 62/930,057, filed on Nov. 4, 2019.

(51) Int. Cl. G06Q 10/06; G06N 20/00; G16Y 10/40; G16Y 20/10; H04W 4/70; H04W 4/029

(52) U.S. Cl. CPC G06Q 10/063114; G06N 20/00; H04W 4/029; G16Y 20/10; H04W 4/70; G16Y 10/40

(57) ABSTRACT

A computer-implemented method, system and a computer program product for providing job status information of an asset to which an IoT device is attached are disclosed. In an example embodiment, the computer implemented method for providing job status information of an asset to which an IoT device is attached includes receiving job information for one or more jobs; receiving location data, vibration data, and speed data from the IoT device attached to the asset. The method further includes evaluating the location data, vibration data, and speed data with respect to the received job information for the one or more jobs to determine the job status of the asset to which the IoT device is attached based on specified conditions.

### CROSS-REFERENCE TO RELATED APPLICATION

This application claims the benefit of U.S. Provisional Patent Application No. 62/930,057, filed on Nov. 4, 2019, entitled “SYSTEM AND METHOD FOR TRACKING AND LEARNING LOCATION AND ACTIVITY OF ASSETS,” which is incorporated herein by reference in its entirety.

### FIELD OF THE INVENTION

The embodiments described herein relate generally to communication networks and more particularly to tracking and learning location and activity data of Internet-of-Things (IoT) devices that are removably attached to assets, connected to a wireless communications network, such as a cellular network, using Internet-of-Things (IoT) devices. The word equipment is used sometimes to represent the asset being tracked.

### BACKGROUND

In many Internet-of-Things (IoT)/Machine-to-Machine (M2M) solutions, particularly implemented on IoT devices removably attached to assets, for example, a vehicle, a generator, etc. it may be useful to track not only the assets, but also determine when a particular asset or part/s of the asset is/are operating, for example, engine of the vehicle, blades on the lawn mower or a turbine on the generator etc.

### SUMMARY

A computer-implemented method, system and a computer program product for providing job status information of an asset to which an IoT device is attached are disclosed.

In an example embodiment, the computer implemented method for providing job status information of an asset to which an IoT device is attached includes receiving job information for one or more jobs; receiving location data, vibration data, and speed data from the IoT device attached to the asset. The method further includes evaluating the location data, vibration data, and speed data with respect to the received job information for the one or more jobs to determine the job status of the asset to which the IoT device is attached based on specified conditions.

In an example embodiment, the system for providing job status information of an asset to which an IoT device is attached includes a storage database, a decision system and a user interface. The storage database receives job information for one or more jobs via user interface and location data, vibration data, and speed data from the IoT device attached to the asset; and the decision system evaluates the location data, vibration data, and speed data received from the IoT device attached to the asset to determine the job status of the asset based on specified conditions.

In an example embodiment, the storage database comprises a location, speed, and activity aware database, wherein the database learns and stores location data and activity data of the IoT device.

In an example embodiment, the non-transitory computer-readable medium having executable instructions stored therein that, when executed, cause one or more processors corresponding to a system for providing job status information for at least one asset to which an IoT device is attached having a database, a decision system and a user interface to perform operations including receiving job information for one or more jobs and receiving location data, vibration data, and speed data of the IoT device attached to the at least one asset. The operations further include evaluating the location data, vibration data, and speed data with respect to the received job information for the one or more jobs to determine the job status of the at least one asset to which the IoT device is attached based on specified conditions.

### BRIEF DESCRIPTION OF THE DRAWINGS

FIG. 1 is an overview diagram for the method and system for providing job status information of an asset according to embodiments described herein.

FIGS. 2a-2c illustrates exemplary configurations and process flows for the system and method for providing job status information of an asset according to embodiments described herein.

FIG. 3 illustrates an exemplary data processing system 300 suitable for storing the computer program product and/or executing program code relating to providing job status information of an asset in accordance with an embodiment described herein.

FIG. 4 illustrates an exemplary process flow for a method and system for engine on/off and state determination used for providing job status information of an asset in accordance with an embodiment described herein.

FIGS. 5a-5g illustrates exemplary graphs of the outputs of the example process flow for a method and system for engine on/off and state determination of FIG. 4 used for providing job status information of an asset in accordance with an embodiment described herein.

FIG. 6a illustrates exemplary travel of the IoT device overlaid on a map in a user interface displayed on a tablet, cell phone, PC, or the like used for providing job status information of an asset in accordance with an embodiment described herein.

FIGS. 6b and 6c illustrate exemplary detected jobs 1 and 2, respectively, at different locations used for providing job status information of an asset in accordance with an embodiment described herein.

### DETAILED DESCRIPTION

The embodiments described herein relate generally to communication networks and more particularly to providing job status information of an asset to which an IoT device is attached, connected to a wireless communications network, such as a cellular network, and that share other characteristics, such as belonging to a commercial fleet of assets such as vehicles. In an embodiment, the IoT device may be attached to the asset removably. The following description is presented to enable one of ordinary skill in the art to make and use the invention and is provided in the context of a patent application and its requirements. Various modifications to the preferred embodiments and the generic principles and features described herein will be readily apparent to those skilled in the art. Furthermore, various embodiments may be combined as those skilled in the art can reasonably conclude that the inventor had possession of the claimed invention regarding the various combinations of the embodiments. Thus, the embodiments described herein are not intended to be limited to the embodiments shown, but is to be accorded the widest scope consistent with the principles and features described herein.

A computer-implemented method, system and a computer program product for providing job status information of an asset to which an IoT device is attached are disclosed.

In an example embodiment, the computer implemented method for providing job status information of an asset to which an IoT device is attached includes receiving job information for one or more jobs; receiving location data, vibration data, and speed data from the IoT device attached to the asset. The method further includes evaluating the location data, vibration data, and speed data with respect to the received job information for the one or more jobs to determine the job status of the asset to which the IoT device is attached based on specified conditions.

In an example embodiment, the system for providing job status information of an asset to which an IoT device is attached includes a storage database, a decision system and a user interface. The storage database receives job information for one or more jobs via user interface and location data, vibration data, and speed data from the IoT device attached to the asset; and the decision system evaluates the location data, vibration data, and speed data received from the IoT device attached to the asset to determine the job status of the asset based on specified conditions.

In an example embodiment, the storage database comprises a location, speed, and activity aware database, wherein the database learns and stores location data and activity data of the IoT device.

In an example embodiment, the non-transitory computer-readable medium having executable instructions stored therein that, when executed, cause one or more processors corresponding to a system for providing job status information for at least one asset to which an IoT device is attached having a database, a decision system and a user interface to perform operations including receiving job information for one or more jobs and receiving location data, vibration data, and speed data of the IoT device attached to the at least one asset. The operations further include evaluating the location data, vibration data, and speed data with respect to the received job information for the one or more jobs to determine the job status of the at least one asset to which the IoT device is attached based on specified conditions.

Many Internet-of-Things (IoT)/Machine-to-Machine (M2M) solutions, particularly operating and removably attached to assets, for example, equipment such as lawn mowers or farming equipment or electricity generators, it may be useful to the fleet operator/job manager to track not only the movement of equipment, but also equipment run-time, run-time of parts of the equipment. For example, for equipment such as lawn mower parts, engine, and blades, who is driving, how they are driving, what job they are working on, when they are expected to complete the job, and/or the location of the equipment. Operators of the IoT assets, for example, driver of the asset performing jobs may not have access to cellular connectivity throughout their job performance, in which case status of the job may be tracked or monitored using location of the equipment, vibration data, speed data, and run-time of parts of the moving asset. Similarly, for equipment such as electricity generator, equipment run-time, run-time of parts of the equipment such as turbine, who is driving and/or running the equipment, how they are driving and/or running the equipment, what job they are working on, when they are expected to complete the job, and/or the location of the equipment.

The location of the asset may provide information whether the asset is at a job site and the run-time of the parts of the asset at the job site may provide information of the status of the job, and based on this information, status of the assigned job may be deduced.

A job may be defined, for example, as an activity of mowing grass at a particular location using one or more assets or generating electricity using a generator etc. Once a job is received, the information regarding the job is entered into the monitoring system including location of the job, equipment information for the equipment/equipments assigned to the particular job, driver information for the driver assigned to transport the equipment/s to the particular job, work team for the particular job, expected start time of the job, expected end time of the job, information of the customer providing the job, etc. For example, the display on the user interface may show one or more of: driver A is driving equipment B at time XX, performing job Y, and the current job status is Z, start time of the job, end time of the job, duration of the job, start & end location, distance driven, area covered, equipment operating time, equipment utilization, and evaluated efficiency (performance) score, etc. In addition, the job may also include machine learned jobs. For example, based on previous job history data, the claimed invention can automatically learn what type of job the work team is performing, location of the job site, etc. In other words, the machine learning of jobs includes using history and analytics to learn job behavior.

The system and method for providing job status information of an asset to which an IoT device is attached and connected to the cellular and/or wireless network described herein can track the status of job, for example, not started, waiting to be started, in progress, completed, etc.; overall on-time completion rate, for example, percentage of jobs completed on-time versus percentage of jobs not completed on-time; job completion performance of drivers or the people who perform the jobs, for example, on-time completion rate; performance metrics for the mowing work team, for example, performance score where higher score means better completion mowing rate. The system and method may also monitor completion rate of jobs for different customers. The fleet operators or job managers, also known as the subscribers may also provide access to their customers for whom the jobs are being performed so that they can see the equipment and work teams that are performing their jobs and also know the expected time, date etc. of completion.

The system and method may additionally or alternatively set up alerts so that customers may know when the jobs are assigned and/or the information of the device performing the job, when the assigned job has started, for example, the mowing equipment or the electricity generator arriving at the job site, and the on-board parts of the equipment has begun mowing operations or electricity generation operations; when the assigned job is about to be completed or is completed; and when the job is completed, for example, the assigned mowing area has been traversed by the mowing equipment with the onboard mowing equipment operating during the traversal or the turbine on the generator has run for a specified amount of time. Similarly, farming equipment, for example, tractor, or other equipment may also be tracked.

The system and method may additionally or alternatively, detect vibration from sensors of the IoT device(s) that are attached/removably attached to the assets as vibration data, may receive location data of the sensors of the IoT device(s) via GPS or other locators, receive speed data of the IoT device, and use the vibration data, location data, and speed data to determine the job status, for example, the mowers are both traversing the assigned mowing area and actually mowing the assigned mowing area.

One of ordinary skill in the art would recognize that the present invention is not limited to mowing equipment, farming equipment or electricity generators etc. For instance, the IoT device may be attached to any asset with or without machinery/equipment that may be monitored or tracked via at least one of vibration data, location data, or speed data or a combination thereof.

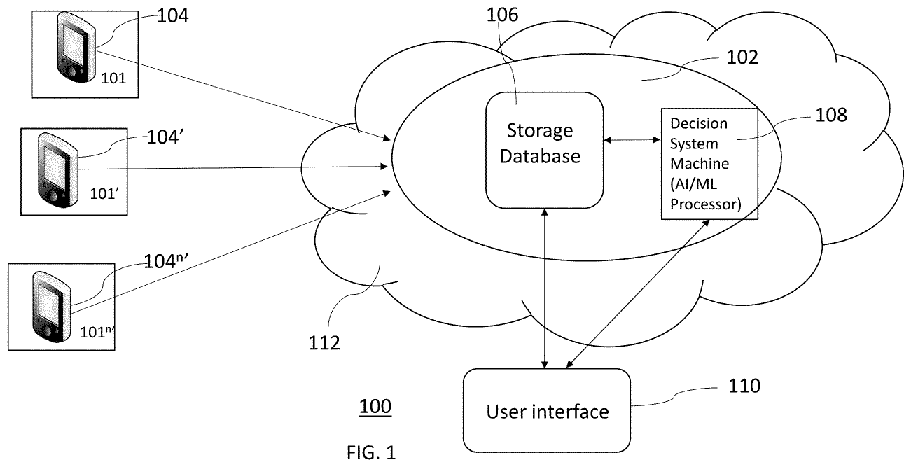

FIG. 1 is an overview diagram for the method and system for providing job status information of an asset to which an IoT device is attached according to an embodiment described herein. FIG. 1 illustrates system configuration 100 including IoT devices 104, 104′ . . . 104n′ attached to assets 101, 101′ . . . 101n′; a data processing system 102, hosted in cloud 112, including a storage database 106 and decision system 108; and a user interface 110. IoT devices 104, 104′ . . . 104n′ may include sensors to measure vibration data and/or speed data, GPS receivers to receive GPS location data, transceivers to send and receive data to storage database 106, and a Telematics Control Unit (TCU) which processes vibration data, location data, and speed data. The storage database 106 receives location data, speed data, and vibration data from the device 104 and job assignment information for the devices 104 from user interface 110. The decision system 108 evaluates the location data, speed data, and activity data to determine the job status of the assets 101, 101′ . . . 101ⁿ′ to which IoT devices 104, 104′, . . . 104n′ are attached based on specified conditions.

The IoT devices 104, 104′, . . . 104ⁿ′ may include communication devices, for example, the IoT devices are connected to the cellular network or cellular-enabled devices via SIMs that are installed in the communication devices either integrated in the asset/s itself/themselves or removably attached to the asset/s as IoT devices, for example, IoT device/s attached to lawn mowing equipment or electricity generator etc. These communication devices could be devices using a radio module, Wi-Fi, or any other wireless communication technology that are capable of transmitting relevant asset/IoT device data to database 106 and/or the data processing system 102 of the monitoring system.

In an exemplary embodiment, once a job is received, information regarding the job is entered into the system including job location, equipment information for the equipment/s assigned to a particular job, driver information for the driver assigned to transport the equipment to the particular job, work team for the particular job, expected start time of the job, expected end time of the job, information of the customer providing the job including name and address of the customer. The system then tracks the location of the assigned device, speed of the assigned device, along with other device data including device activity and vibration data. The system thus tracks the status of the assigned jobs based on the location of the device/equipment and activity data including vibration data, for example, jobs (not started, in progress, idle, completed).

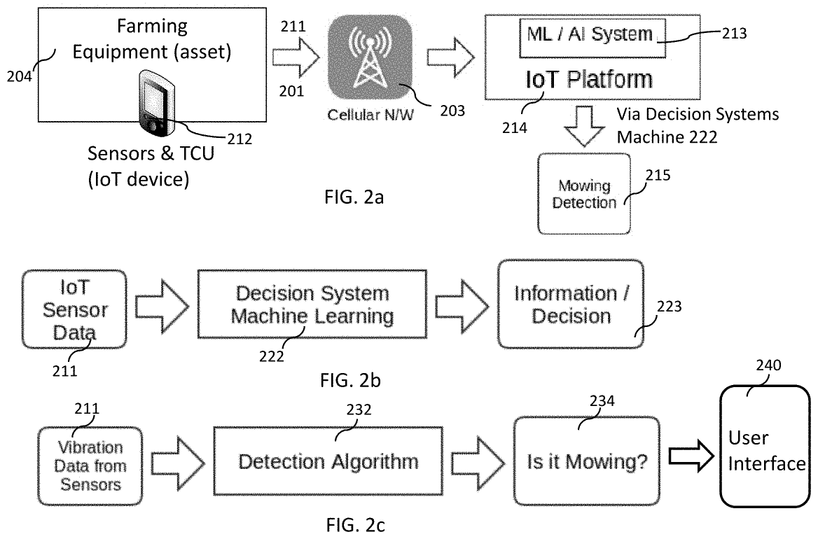

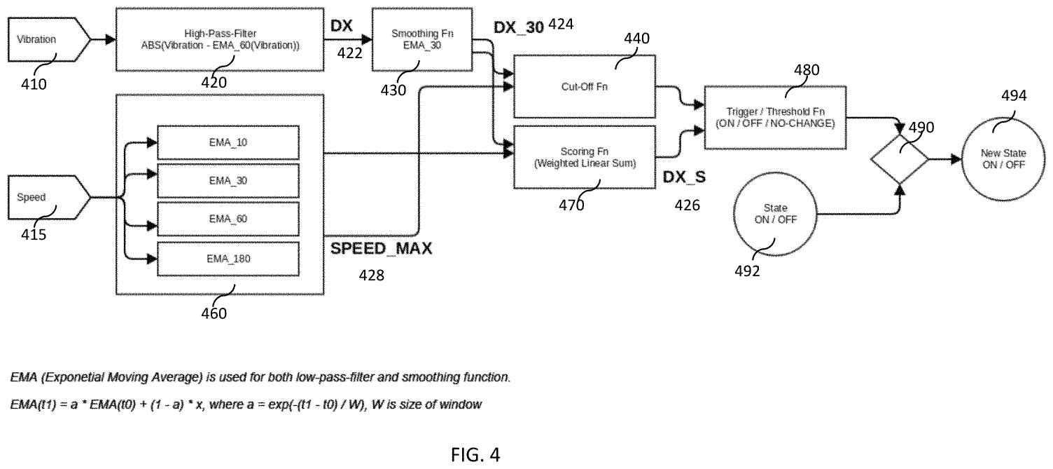

FIGS. 2a-2c illustrate example configurations and process flows for the method and system for providing job status information of an asset to which an IoT device is attached, for example, mowing detection, according to one or more embodiments described herein. In FIG. 2a, for example, step 201, vibration data, speed data, and location data, i.e. IoT Sensor Data 211, detected by the sensors and processed by the TCU (IoT device) 212 of the asset 204, for example, farming equipment such as a lawn mower, is sent via a Cellular Network 203 to storage database 206 of the ML/AI System 213 which is part of the IoT Platform 214. The ML/AI System 213 then accesses the IoT Sensor Data 211 stored in the storage database 206 and processes the IoT Sensor Data 211 via a decision system 222 for Mowing Detection in block 215. In an embodiment, the storage database 206 may be included in the ML/AI system or may be separate from the ML/AI system 213. The decision system and machine learning and analysis 222 is further described in FIG. 4.

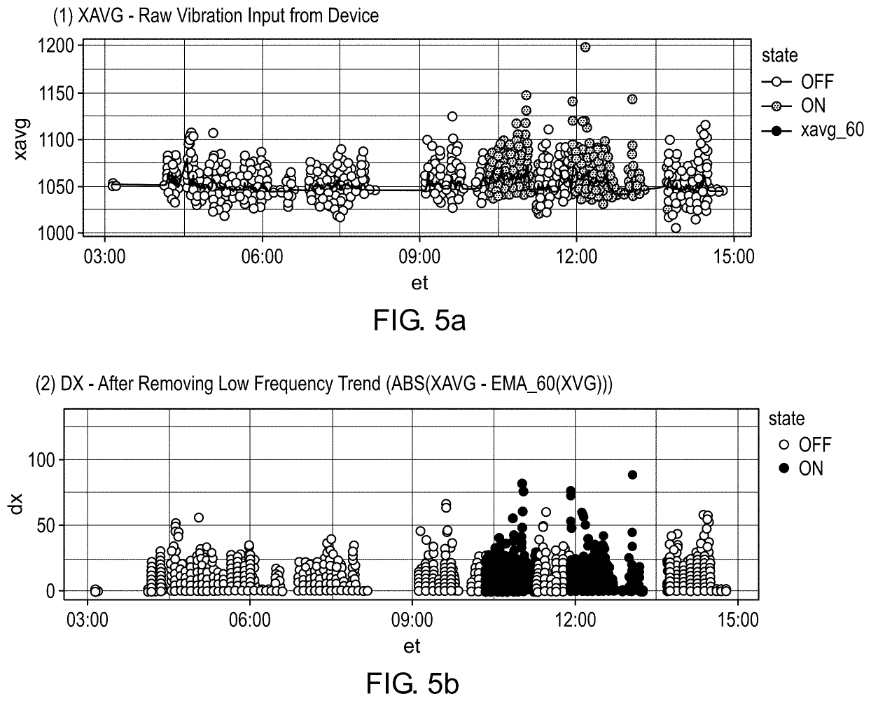

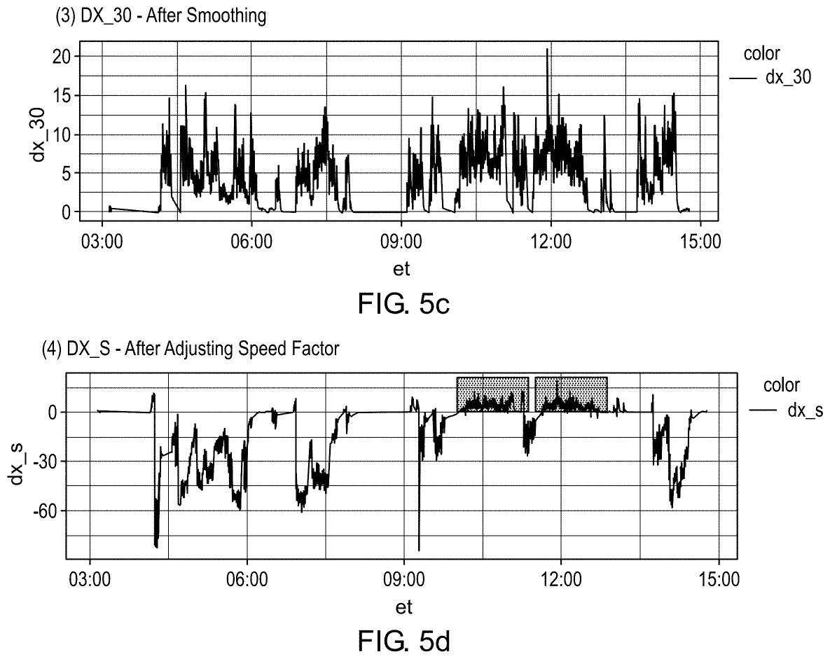

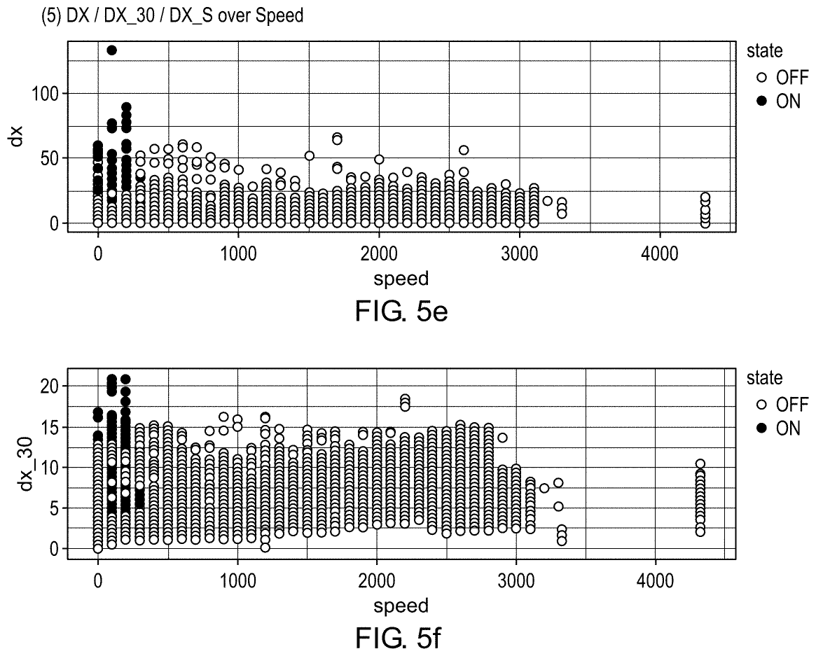

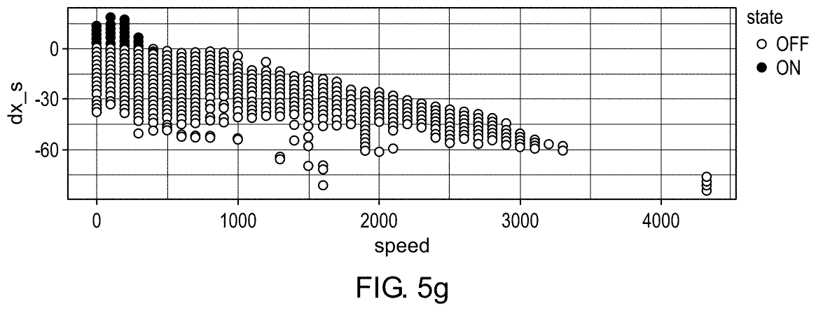

In FIG. 2b, for example, IoT Sensor Data 211 is inputted into a decision system 222 that learns and analyzes at least one of the vibration data, speed data, or location data of the IoT Sensor Data 211, and processes this information to make a decision 223 to determine whether the parts of the equipment attached to the device 204 are operating, i.e. mowing grass in a job status determination via a detection algorithm 232, as further described in FIG. 4. The decision system 222 implements a learning algorithm based on the results of the job status determination to more accurately predict future activity of the equipment. The learning algorithm can then be implemented in the cloud or on the user device. An exemplary learning algorithm used by one or more embodiments of the present invention is illustrated in FIGS. 4 and 5a-5f and is described in the description accompanying FIGS. 4 and 5a-5f.

In FIG. 2c, for example, decision system runs through the logic process in the Detection Algorithm 232, for example, if the mowing asset(s) is not at the job site, the job status may be determined as “Mowing in Progress—No”. If the asset is at the job site, in motion, vibration is detected and between a predetermined acceptable range or if the vibration threshold is reached, and the speed data is between a predetermined range the job status may be determined as “in progress”. This information may be accessed by web-based application or mobile application via user interface 240.

The Acceptable range for vibration is defined by lower-bound (LB) & upper-bound (UB) level of vibration, which is derived from historic data gathered for each device, for example, device X may have an acceptance range of UB: 1200 LB: 700, and another device Y can have a different acceptance range of UB: 1500 LB: 500. The acceptable range of vibration may be determined in various ways, for example, heuristic methods with experiments; a machine learning process against history data such as classification and/or clustering etc. Mobile or Web client may compile the data into meaningful report and present it to the user via user interface 240.

In order to determine whether the vibration threshold is reached, the vibration data is processed through a filter, for example, low pass, hi pass, and/or low and hi-pass filters to minimize false positive or negative indications that the lawn mower blades are operating (on), as further described in FIG. 4. In an exemplary embodiment, the low-pass and/or high-pass filters can be implemented in various ways including Fourier Transform (FT) and Exponential Moving Average (EMA). The reference example is using EMA. EMA(t)=a*EMA(t−dt)+(1−a)*x(t), where x(t) is input data, a=exp(−dt/W), dt is time difference, and W is size of window. For example, the vibration can processed by high-pass-filter first to remove slowly moving trend, and followed by low-pass-filter to remove high-frequency noise, i.e. EMA(x(t)−EMA(x(t))) where x(t) is the input raw vibration. (Using EMA as low-pass-filter, x(t)−EMA(x(t)) as high-pass-filter).

Other scenarios regarding the job status in the logic process in the Detection Algorithm 232 is described below in Table 1:

TABLE 1
Job Status

| | | | | Speed | | |
|---|---|---|---|---|---|---|
| | | | Vibration | within | | |
| Equipment | Equipment | Vibration | Threshold | acceptable | Mowing in | |
| at Job Site | in Motion | Data | Reached | range | Progress | Idle |
| Y | Y | Y | Y | Y | Y | N |
| Y | Y | Y | Y | N | N | N |
| Y | Y | Y | N | N/A | N | N |
| Y | Y | N | N | N/A | N | N |
| Y | N | Y | Y | N/A | N | Y |
| Y | N | Y | N | N/A | N | N |
| N | N | Y | N | N/A | N | N |
| N | Y | Y | N | N/A | N | N |

The system and method may use other naming system and criteria to determine the job status for the IoT device.

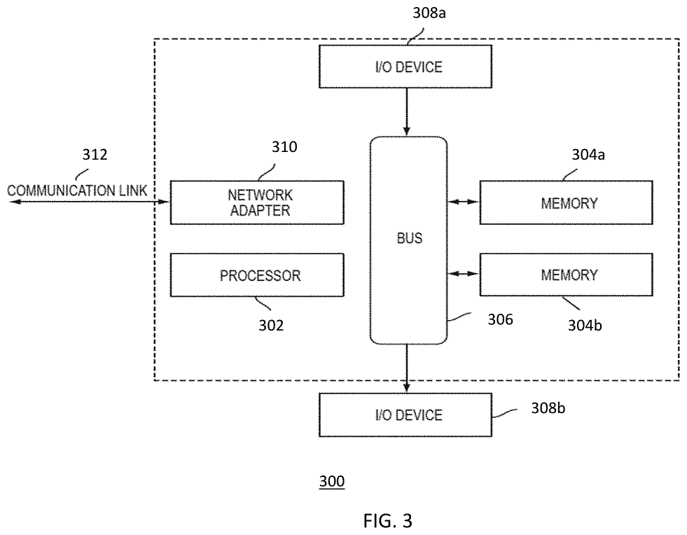

FIG. 3 illustrates a data processing system 300 suitable for storing the computer program product and/or executing program code in accordance with an embodiment of the present invention. The data processing system 300 includes a processor 302 coupled to memory elements 304a-b through a system bus 306. In other embodiments, the data processing system 300 may include more than one processor and each processor may be coupled directly or indirectly to one or more memory elements through a system bus.

Memory elements 304a-b can include local memory employed during actual execution of the program code, bulk storage, and cache memories that provide temporary storage of at least some program code in order to reduce the number of times the code must be retrieved from bulk storage during execution. As shown, input/output or I/O devices 308a-b (including, but not limited to, keyboards, displays, pointing devices, etc.) are coupled to the data processing system 300. I/O devices 308a-b may be coupled to the data processing system 300 directly or indirectly through intervening I/O controllers (not shown).

In FIG. 3, a network adapter 310 is coupled to the data processing system 302 to enable data processing system 302 to become coupled to other data processing systems or remote printers or storage devices through communication link 312. Communication link 312 can be a private or public network. Modems, cable modems, and Ethernet cards are just a few of the currently available types of network adapters.

FIG. 4 is an example process flow for a method and system for engine on/off and state determination by the ML/AI System 213 of the IoT Platform 214 shown in FIG. 2, used for providing job status information of an asset to which an IoT device is attached according to the embodiments described herein. As illustrated in FIG. 4, Raw Vibration Input Data (XAVG) 410 from the device is sent to a high pass filter shown as block 420. High Pass-Filter 420 removes Low Frequency Trend according to the equation ABS(XAVG−EMA_60 (XVG)), which results in DX 422. EMA (Exponential Moving Average) is used for both low-pass-filter and smoothing function and calculated via EMA(t1)=a*EMA(t0)+(1−a)*x, where a=exp(−(t1−t0)/W), W is size of window. EMA is a weighted moving average that gives more weighting, or importance, to recently acquired data than the simple moving average. DX 422 is then smoothed via a Smoothing Function EMA_30 430 which results in DX_30 424. DX_30 424 is then processed with a Cut-Off Fn 440.

Further, in FIG. 4, Speed Data 415 from the device is sent to a Low Pass-Filter 460, where trend of speed is derived from various sized windows of time series speed data”. In the example system, the trend function is max(EMA_10, EMA_30, EMA_60, EMA_180). EMA_W(t1)=a*EMA_W(t0)+(1−a)*speed(t1), where a=exp(−(t1−t0)/W), and W is size of window. For example, for t=10, 30, 60 seconds, and 180, W=10, 30, 60, and 180 seconds respectively.

The Low Pass-Filter filters the speed data according to the equation EMA(t1)=a*EMA(t0)+(1−a)*x, where a=exp(−(t1−t0)/W), W is size of window, for t=10, 30, 60, and 180 seconds which results in a SPEED MAX 428. The SPEEDMAX 428 of the process in this example is simply maximum value of all windowed input speed values, for example, SPEEDMAX=max(EMA_10 (t), EMA_30 (t), EMA_60(t), EMA_180(t)). Both the results of block 460 and DX-30 424 are input to the Scoring function 470 for Weighted Linear Sum calculation for adjusting a speed factor DX_S 426. The resultant adjusted speed factor DX_S 426 and output of the Cu-Off function 440 is then evaluated for a Trigger/Threshold function 480 for On/Off/No-Change. Upon determination of output from 440 and DX_S by the Trigger/Threshold function 480, a decision of the State being On/Off 492 or the New State On/Off circle 494 is determined at 490. Thus, 490 may be defined as a logical point to determine the final state 494, from trigger 480 and previous state 492, for example,

If trigger 480 is ON then:

New-state 494←ON

Else if trigger 480 is OFF then:

New-state 494←OFF

Else if previous state 492 is ON then:

New-state 494←ON

### Else

New-state 494←OFF

For example, DX_S 426 may be evaluated as DX_S=DX_30+w1*SPEED_MAX+w0 and the weights w1, w0 may be either determined by heuristic methods or fitted by ML training process. The Cut-Off function 440 may validate various features (both inputs and derived features) against acceptable ranges to reduce false positive and/or false negative.

FIGS. 5a-5f depict various graphs of the outputs of the example process flow for a method and system for engine on/off and state determination by the ML/AI System 213 of the IoT Platform 214 of FIG. 2 used for providing job status information of an asset to which an IoT device is attached according to one or more embodiments of the present invention.

FIG. 5a depicts (1) XAVG—Raw Vibration Input 410 shown in FIG. 4 from the device over time in “Off”, “ON” states. The off/on states are derived from raw vibration data along with slowly moving trend, xavg_60 (EMA_60 (XAVG)), wherein the slowly moving trend is used for removal of noise and xavg_60 is a moving average at t=60 seconds. FIG. 5a depicts the input values to evaluate DX shown in FIG. 5b. As DX is defined as abs(xavg−xavg_60), FIG. 5a shows xavg_60 as well, in addition to the raw vibration input xavg. As described above, DX is the derived value through High Pass-Filter, which will indicate vibration with high frequency.

FIG. 5b depicts (2) DX 422 shown in FIG. 4 after Removing Low Frequency Trend (ABS(XAVG-EMA_60 (XAVG))) over time in an off and on state. The on and off states are derived from raw vibration data.

FIG. 5c depicts (3) DX_30 424 shown in FIG. 4 after Smoothing over time (DX_30=EMA_30(DX)).

FIG. 5d depicts (4) DX_S 426 shown in FIG. 4 after Adjusting Speed Factor over time. (DX_S=DX_30+W1*ADJUSTED_SPEED+W0). As shown in FIGS. 5e-5g, only DX_S (compared with DX, DX_30) can separate the data points into target classes (mowing job ON/OFF). This is potentially because the vibration is contributed not only by mowing job but also by moving/transfer of the equipment used to perform jobs. To reflect this, speed is used as a feature, where moving average of speed values is used rather than speed at a particular instance to prevent abrupt noise.

FIGS. 5e-5g depicts (5) DX/DX_30/DX_S over Speed in an OFF and ON state used for providing job status information of an asset to which an IoT device is attached according to one or more embodiments of the present invention.

FIG. 5g shows, for the transformed feature DX_S 426 shown in FIG. 4, the predicate DX_S>0 will separate (or classify) the data points into ON and OFF states. This DX_S is then used for making decision regarding on/off states as illustrated by 480 in FIG. 4.

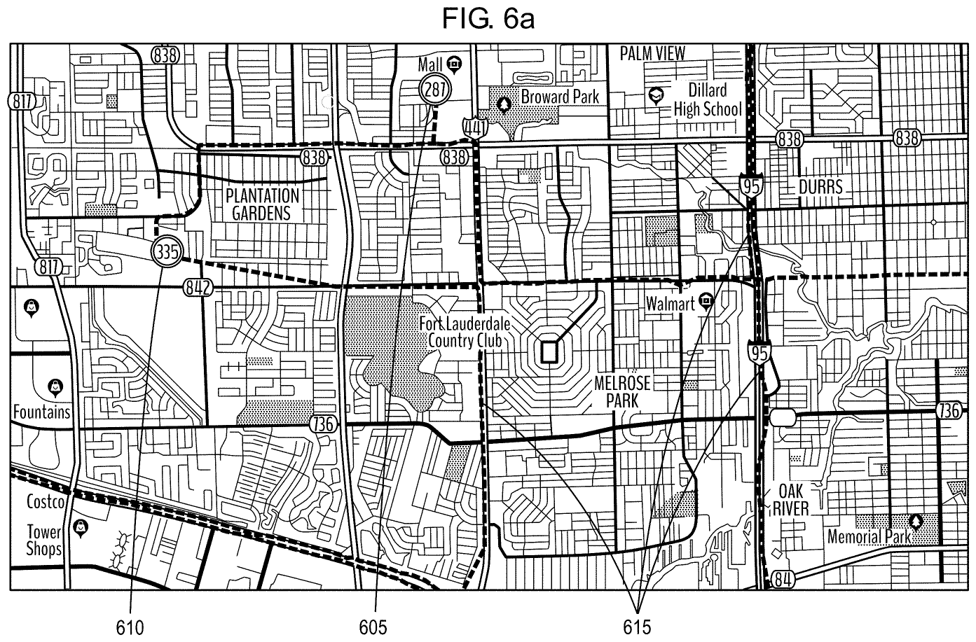

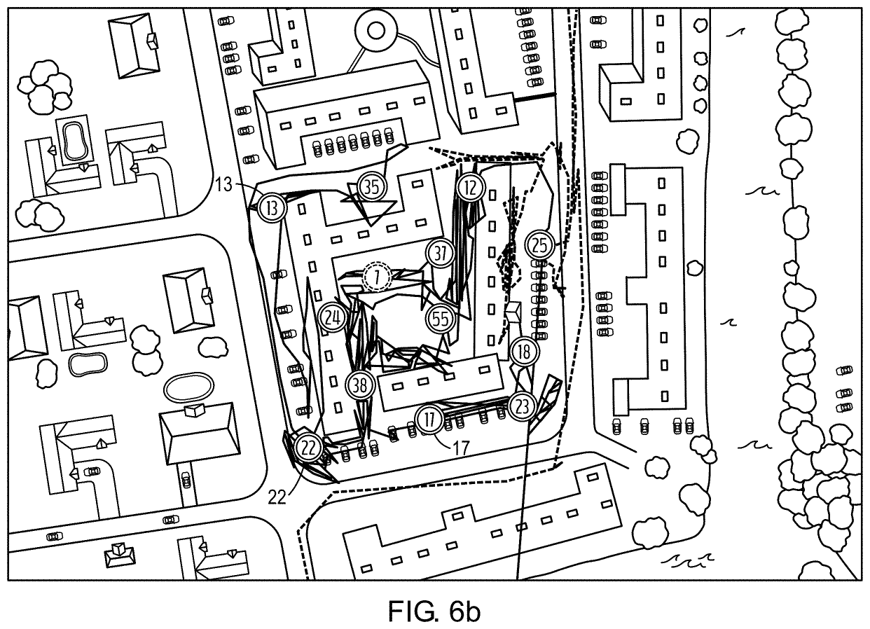

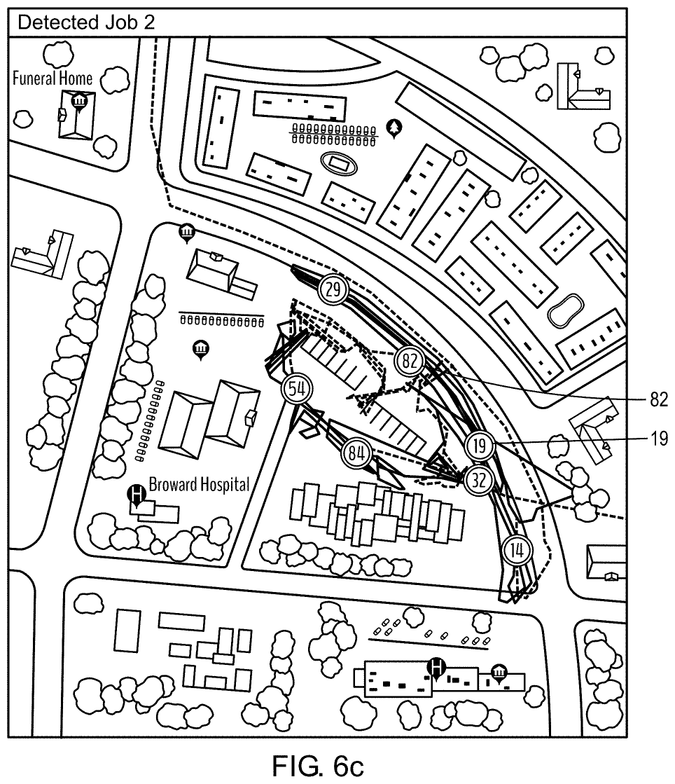

FIG. 6a depicts travel of the device overlaid on a map including markers 287 and 335 of mowing locations 605 and 610 respectively, in an exemplary user interface displayed on a tablet, cell phone, PC, or the like used for providing job status information of an asset to which an IoT device is attached according to one or more embodiments of the present invention. For example, the thick dash lines 615 on the map represent movement of the equipment, for example, a lawn mower carried by a truck, on a map, and markers 605 and 610 represent movement of the equipment, for example, a lawn mower, while performing a job.

FIGS. 6b and 6c depict Detected Jobs 1 and 2, respectively at different locations including markers, for example, 13, 17, 22 in FIGS. 6b and 19, 82 in FIG. 6c etc. represent data points classified as mowing job (ON) used for providing job status information of an asset to which an IoT device is attached according to one or more embodiments of the present invention.

Embodiments of the process described herein can take the form of an entirely software implementation, or an implementation containing both hardware and software elements. Embodiments may be implemented in software, which includes, but is not limited to, application software, firmware, resident software, microcode, etc.

The steps described herein may be implemented using any suitable controller or processor, and software application, which may be stored on any suitable storage location or computer-readable medium. The software application provides instructions that enable the processor to cause the receiver to perform the functions described herein.

Furthermore, embodiments may take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include DVD, compact disk-read-only memory (CD-ROM), and compact disk-read/write (CD-R/W).

Any theory, mechanism of operation, proof, or finding stated herein is meant to further enhance understanding of the present invention and is not intended to make the present invention in any way dependent upon such theory, mechanism of operation, proof, or finding. It should be understood that while the use of the words “preferable”, “preferably” or “preferred” in the description above indicates that the feature so described may be more desirable, it nonetheless may not be necessary and embodiments lacking the same may be contemplated as within the scope of the invention, that scope being defined by the claims that follow. In addition, it should be understood that while the use of words indicating a sequence of events such as “first” and “then” shows that some actions may happen before or after other actions, embodiments that perform actions in a different or additional sequence should be contemplated as within the scope of the invention as defined by the claims that follow.

As used herein, the term “cellular communication” is understood to include various methods of connecting any type of computing or communications devices, servers, clusters of servers, using wired and/or wireless communications networks to enable processing and storage of signals and information, and where these services may be accessed by applications available through a number of different hardware and software systems, such as but not limited to a web browser terminal, mobile application (i.e., app) or similar, and regardless of whether the primary software and data is located on the communicating device or are stored on servers or locations apart from the devices.

As used herein the terms “device”, “appliance”, “terminal”, “remote device”, “wireless asset”, etc. are intended to be inclusive, interchangeable, and/or synonymous with one another and other similar communication-based equipment for purposes of the present invention, even though one will recognize that functionally each may have unique characteristics, functions and/or operations which may be specific to its individual capabilities and/or deployment.

Similarly, it is envisioned by the present invention that the term “wireless network” includes networks using one or more communication architectures or methods, including but not limited to: Code division multiple access (CDMA), Global System for Mobile Communications (GSM) (“GSM” is a trademark of the GSM Association), Universal Mobile Telecommunications System (UMTS), Long Term Evolution (LTE), 4G LTE, 5G, wireless local area network (WIFI) or Bluetooth and Ethernet.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the present invention.

What is claimed is:

1. A computer-implemented method for providing job status information of at least one asset to which an IoT device is attached comprising:
receiving job information for one or more jobs;
receiving location data, vibration data, and speed data from the IoT device attached to the at least one asset; and
evaluating the location data, vibration data, and speed data with respect to the received job information for the one or more jobs to determine the job status of the at least one asset to which the IoT device is attached based on a specified condition.

2. The computer-implemented method of claim 1, wherein the job information for the one or more jobs comprises any one or more of: location of the job, equipment information for the one or more equipment assigned to the job, driver information for the driver assigned to transport the one or more equipment to the job, work team assigned for the job, expected start time of the job, expected end time of the job and information of the customer providing the job.

3. The computer-implemented method of claim 1, wherein the one or more jobs comprise machine learned jobs, wherein the machine learning of jobs includes using history and analytics to learn job behavior.

4. The computer-implemented method of claim 1, wherein the IoT device includes a communication device enabled for cellular or other wireless communication via SIMs installed in the communication device.

5. The computer-implemented method of claim 1, wherein evaluating the location data with respect to job information for the one or more jobs includes comparing location of the job with the location of the IoT device.

6. The computer-implemented method of claim 1, wherein evaluating the vibration data includes detecting vibration of the IoT device based on a predetermined acceptable range of vibration or vibration threshold.

7. The computer-implemented method of claim 6, wherein the acceptable range of vibration is defined by lower-bound (LB) & upper-bound (UB) level of vibration.

8. The computer-implemented method of claim 6, wherein determining if the IoT device has reached the vibration threshold includes processing the vibration data through a filter to minimize false positive or negative, and where the filter includes any one or more of: low pass filter, hi pass filter or a combination thereof.

9. The computer-implemented method of claim 1, wherein evaluating the speed data includes detecting speed of the IoT device, calculating moving average of the speed value and deriving trend of speed from various sized windows of time series speed data.

10. A system for providing job status information of at least one asset to which an IoT device is attached comprising:
a storage database, wherein the storage database receives
receives job information for one or more jobs, and
location data, vibration data, and speed data from the IoT device attached to the at least one asset; and
a decision system including a processor, wherein the decision system evaluates the location data, vibration data, and speed data with respect to the received job information for the one or more jobs to determine the job status of the at least one asset to which an IoT device is attached based on a specified condition.

11. The system of claim 10, wherein the job information for the one or more jobs comprises any one or more of: location of the job, equipment information for the one or more equipment assigned to the job, driver information for the driver assigned to transport the one or more equipment to the job, work team assigned for the job, expected start time of the job, expected end time of the job and information of the customer providing the job.

12. The system of claim 10, wherein the one or more jobs comprise machine learned jobs, wherein the machine learning of jobs includes using history and analytics to learn job behavior.

13. The system of claim 10, wherein the IoT device includes a communication device enabled for cellular or other wireless communication via SIMs installed in the communication device.

14. The system of claim 10, wherein evaluating the location data with respect to job information for the one or more jobs includes comparing location of the job with the location of the IoT device.

15. The system of claim 10, wherein evaluating the vibration data includes detecting vibration of the IoT device based on a predetermined acceptable range of vibration or vibration threshold.

16. The system of claim 15, wherein the acceptable range of vibration is defined by lower-bound (LB) & upper-bound (UB) level of vibration.

17. The system of claim 15, wherein determining if the IoT device has reached the vibration threshold includes processing the vibration data through a filter to minimize false positive or negative, and where the filter includes any one or more of: low pass filter, hi pass filter or a combination thereof.

18. The system of claim 10, wherein evaluating the speed data includes detecting speed of the IoT device, calculating moving average of the speed value and deriving trend of speed from various sized windows of time series speed data.

19. A non-transitory computer-readable medium having executable instructions stored therein that, when executed, cause one or more processors corresponding to a system for providing job status information of at least one asset to which an IoT device is attached having a database, a decision system and a user interface to perform operations comprising:
receiving job information for one or more jobs;
receiving location data, vibration data, and speed data of the at least one IoT device attached to the at least one asset; and
evaluating the location data, vibration data, and speed data with respect to the received job information for the one or more jobs to determine the job status of the at least one asset to which the IoT device is attached based on a specified condition.

20. The non-transitory computer-readable medium of claim 19, wherein the job information for the one or more jobs comprises any one or more of: location of the job, equipment information for the one or more equipment assigned to the job, driver information for the driver assigned to transport the one or more equipment to the job, work team assigned for the job, expected start time of the job, expected end time of the job and information of the customer providing the job.

21. The non-transitory computer-readable medium of claim 19, wherein the one or more jobs comprise machine learned jobs, wherein the machine learning of jobs includes using history and analytics to learn job behavior.

22. The non-transitory computer-readable medium of claim 19, wherein the IoT device includes a communication device enabled for cellular or other wireless communication via SIMs installed in the communication device.

23. The non-transitory computer-readable medium of claim 19, wherein evaluating the location data with respect to job information for the one or more jobs includes comparing location of the job with the location of the IoT device.

24. The non-transitory computer-readable medium of claim 19, wherein evaluating the vibration data includes detecting vibration of the IoT device based on a predetermined acceptable range of vibration or vibration threshold.

25. The non-transitory computer-readable medium of claim 24, wherein the acceptable range of vibration is defined by lower-bound (LB) & upper-bound (UB) level of vibration.

26. The non-transitory computer-readable medium of claim 24, wherein determining if the IoT device has reached the vibration threshold includes processing the vibration data through a filter to minimize false positive or negative, and where the filter includes any one or more of: low pass filter, hi pass filter or a combination thereof.

27. The non-transitory computer-readable medium of claim 19, wherein evaluating the speed data includes detecting speed of the IoT device, calculating moving average of the speed value and deriving trend of speed from various sized windows of time series speed data.
